(19) United States
(12) Patent Application Publication
(10) Pub. No.: US 2025/0018326 A1
(43) Pub. Date: Jan. 16, 2025

(54) DISTRIBUTED CONTAMINANT REMOVAL USING LIQUID SORBENT

(71) Applicant: Honeywell International Inc., Charlotte, NC (US)

(72) Inventors: Rebecca Kamire, Buffalo Grove, IL (US); Emir Rahislic, Chicago, IL (US); Mark Triezenberg, Westmont, IL (US); Phoebe Henson, Glendale, AZ (US)

(21) Appl. No.: 18/352,912

(22) Filed: Jul. 14, 2023

(51) Int. Cl. B01D 53/14

(52) U.S. Cl. CPC B01D 53/1425; B01D 53/1475; B01D 2252/30; B01D 2257/108; B01D 2257/2064; B01D 2257/2066; B01D 2257/406; B01D 2257/502; B01D 2257/504; B01D 2257/556; B01D 2257/7027; B01D 2259/4575

(57) ABSTRACT

A contaminant removal system includes a contaminant desorption system and two or more contaminant sorption systems. The contaminant desorption system includes at least one stripper configured to desorb one or more contaminants from a liquid sorbent. The one or more contaminants include at least carbon dioxide. Each contaminant sorption system includes at least one scrubber and a liquid sorbent circuit. Each scrubber is configured to absorb the one or more contaminants from an air stream into the liquid sorbent. The liquid sorbent circuit is configured to circulate the liquid sorbent between the at least one scrubber and the at least one stripper of the contaminant desorption system.

### GOVERNMENT RIGHTS

This invention was made with Government support under Grant Contract Number 80MSFC18C0045 awarded by National Aeronautics and Space Administration (NASA) Marshall Space Flight Center. The Government has certain rights in the invention.

### TECHNICAL FIELD

The present disclosure relates to systems and techniques for removing contaminants from two or more environments using contaminant removal systems.

### BACKGROUND

An environmental control system (ECS) may provide conditioned air to a passenger cabin or other environment. Some of this conditioned air may be treated to remove contaminants. ECS components that are used to remove contaminants may be large and heavy, increasing an overall weight of the ECS, and may consume large amounts of power heating, cooling, and pressurizing various fluid streams. Further, the contaminants generated in particular portions of the environment may differ. For example, contaminants, such as carbon dioxide, that are generated in a cabin as a result of biological processes may differ from contaminants, such as hydrocarbons, that are generated in a mechanical room as a result of mechanical processes.

### SUMMARY

The disclosure describes systems and techniques for removing contaminants, including carbon dioxide, from various atmospheres using liquid sorbents, such as ionic liquid sorbents.

A contaminant removal system is configured to remove contaminants using a liquid sorbent. In addition to providing a high capacity for contaminants, use of a liquid sorbent as an intermediate transport medium may enable physical and functional separation of components that remove contaminants from an air stream and components that perform other functions, such as desorption of contaminants or processing of contaminants. The contaminant removal system is separated into one or more contaminant sorption systems that absorb contaminants into the liquid sorbent and one or more contaminant desorption systems that desorb the contaminants from the liquid sorbent. Each contaminant sorption system may be responsible for removing contaminants from an air stream having a particular composition based on contents of the atmosphere and returning a clean air stream having a particular composition based on requirements for the atmosphere. Due to this distributed configuration, contaminant sorption system may be physically separated from the contaminant desorption system and may be sized and/or operated in a manner specific for the particular air streams. Desorption of contaminants from the liquid sorbent may be consolidated into one or more contaminant desorption systems, which may be located away from the various atmospheres treated by the contaminant sorption systems. As a result, contaminant removal systems described herein may be more responsive to (e.g., more quickly change) changes in contaminant concentrations and/or have a smaller overall volume or size than contaminant removal systems that do not separate and distribute contaminant sorption and desorption functions.

In some examples, the disclosure describes a contaminant removal system. The system includes a contaminant desorption system and one or more contaminant sorption systems. The contaminant desorption includes at least one stripper located in a remote environment and configured to desorb one or more contaminants from a liquid sorbent. The one or more contaminants include at least carbon dioxide. Each contaminant sorption system includes at least one scrubber located in a local environment from the remote environment and at a liquid sorbent circuit. Each scrubber is configured to absorb the one or more contaminants from an air stream into the liquid sorbent. The liquid sorbent circuit is configured to circulate the liquid sorbent between the at least one scrubber and the at least one stripper of the contaminant desorption system. In some examples, the system described above includes two or more contaminant sorption systems. Each of the two or more contaminant sorption systems is configured to receive the respective air stream from different environments, such as environments that may have different concentrations of contaminants.

In some examples, the disclosure describes a contaminant removal system. The system includes a contaminant desorption system and two or more contaminant sorption systems. The contaminant desorption system includes at least one stripper configured to desorb one or more contaminants from a liquid sorbent. The one or more contaminants include at least carbon dioxide. Each contaminant sorption system includes at least one scrubber and a liquid sorbent circuit. Each scrubber is configured to absorb the one or more contaminants from an air stream into the liquid sorbent. The liquid sorbent circuit is configured to circulate the liquid sorbent between the at least one scrubber and the at least one stripper of the contaminant desorption system.

In some examples, the disclosure describes a method for removing contaminants from an environment includes absorbing, by a first contaminant sorption system, one or more contaminants from a first cabin air stream using a liquid sorbent and absorbing, by a second contaminant sorption system, one or more contaminants from a second cabin air stream using the liquid sorbent. The method further includes desorbing, by a contaminant desorption system, the one or more contaminants from the liquid sorbent.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a block diagram illustrating an example contaminant removal system for absorbing contaminants using a contaminant sorption system in a remote environment and desorbing contaminants using a contaminant desorption system in a central environment.

FIG. 2 is a block diagram illustrating an example contaminant removal system for absorbing contaminants using different contaminant sorption systems and desorbing contaminants using a same contaminant desorption system.

FIG. 3A is a schematic diagram illustrating an example contaminant sorption system of a contaminant removal system.

FIG. 3B is a schematic diagram illustrating an example contaminant desorption system of a contaminant removal system.

FIG. 4 is an example flowchart of a method for absorbing contaminants using different contaminant sorption systems and desorbing contaminants using a same contaminant desorption system.

FIG. 5 is a block diagram illustrating an example contaminant removal system for absorbing contaminants using different contaminant sorption systems and desorbing contaminants using different contaminant desorption systems.

### DETAILED DESCRIPTION

The disclosure describes systems and techniques for removing contaminants, including carbon dioxide and water, from cabin air using liquid sorbents. Rather than absorb and desorb contaminants from a same environment, or absorb contaminants from a single environment, a contaminant removal system is configured to absorb contaminants from one or more environments and desorb the contaminants at a centralized location. By using distributed systems for absorbing contaminants from local and/or multiple environments, contaminant removal systems may more efficiently remove contaminants from the environments.

Contaminant removal systems described herein may be utilized as part of an environmental control system (ECS), such as in spacecraft, aircraft, watercraft, and the like. In some examples, contaminant removal systems may be used in an ECS of a resource-limited environment, such as a spacecraft, in which a wide variety of contaminants may be generated at different locations within the environment. Such resource-limited environments may be particularly suited for a contaminant removal system that includes components that use low amounts of power and have extended service lives to reduce overall weight, power consumption, and maintenance load.

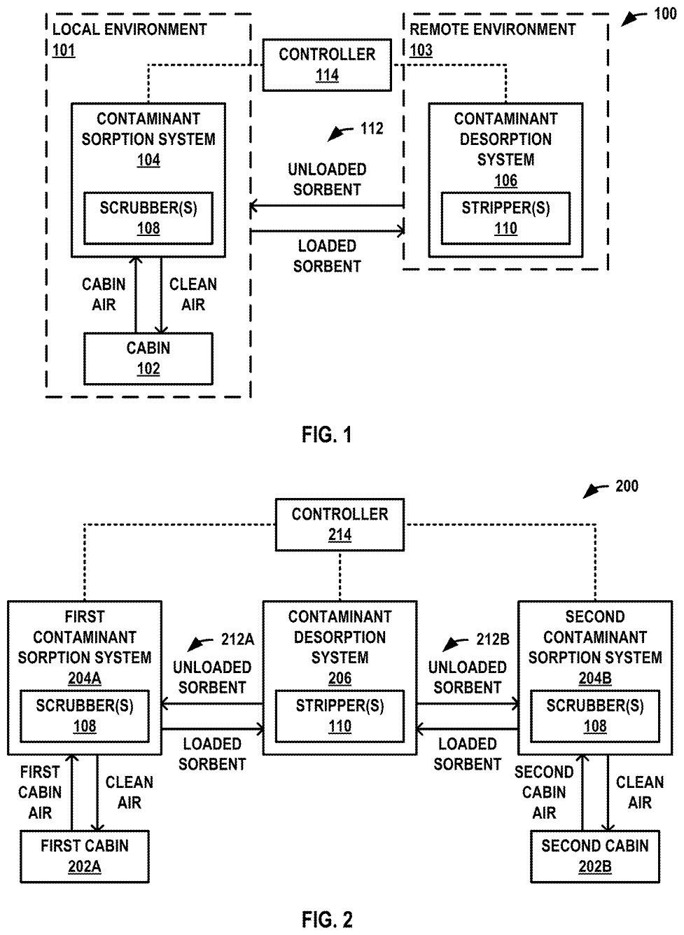

FIG. 1 is a block diagram illustrating an example contaminant removal system 100 for absorbing contaminants using a contaminant sorption system 104 in a local environment 101 and desorbing contaminants using a contaminant desorption system 106 in a remote environment 103. Contaminant removal system 100 is configured to remove contaminants from a cabin 102. Cabin 102 may include any enclosed and controlled atmosphere, and may include any combination of personnel, machinery, or equipment. Cabin 102 may be a controlled environment, such as an aircraft cabin, spacecraft cabin, watercraft cabin, or the like, and contaminants removed from cabin 102 may include, but are not limited to, carbon dioxide, water, hydrocarbons, permanent gases, or the like. In some examples, cabin 102 is a cabin of a closed-loop system, such as a spacecraft cabin or submarine cabin, in which components of a cabin air stream from cabin 102, such as carbon dioxide and water, may be removed within contaminant removal system 100, allowing a purified supply air stream to be generated and carbon dioxide and water to be recovered. However, in other examples, cabin 102 is a cabin of an open-loop system, such as an aircraft cabin, in which components of a cabin air stream may be removed to generate a purified supply air stream with only partial or no subsequent recovery of the contaminants.

System 100 is configured to remove at least a portion of the contaminants using one or more liquid sorbents. A liquid sorbent may include any liquid configured to absorb and desorb a gaseous species. Liquid sorbents may be water soluble, hygroscopic (i.e., capable of absorbing moisture from the air), capable of absorbing or desorbing contaminants in response to a change in solubility driven by a change in temperature, and/or capable of releasing water by evaporation, such as by elevating the temperature or reducing the water partial pressure. In some examples, the liquid sorbent may be an ionic liquid sorbent. Ionic liquid sorbents may be salts that are generally comprised of an anion and an organic cation. These salts may be liquid at their temperature of use, have effectively zero vapor pressure, be generally nontoxic, and/or have sufficient stability to resist deterioration. In some examples, ionic liquid sorbents may contain relatively large organic cations and any of a variety of anions, which may be tailored to obtain desired characteristics, such as characteristics that improve absorption of the particular contaminant under operating conditions of contaminant removal system 100. A variety of ionic liquid sorbents may be used including, but not limited to, imidazole salts, such as 1-ethyl-3-methylimidazolium (EMIM) acetate (Ac).

In system 100, the liquid sorbent is dissolved in water to form a liquid sorbent mixture. A concentration of liquid sorbent in the liquid sorbent mixture may be sufficiently high to remove a particular or set of contaminants and sufficiently low that the liquid sorbent remains in solution through operating ranges (e.g., temperature range, pH range) and/or maintains a low viscosity for maintaining high mass transfer. In some examples, the liquid sorbent mixture may further include a dissolved promoter. The promoter may be configured to increase a rate of removal of a contaminant, such as water or carbon dioxide, from an air stream. For example, the promoter may be configured to reduce a viscosity of the liquid sorbent, change a pH of the liquid sorbent, increase a thermal stability of the liquid sorbent, increase a capacity of the liquid sorbent for the contaminant, or increase an absorption rate of the contaminant into the liquid sorbent.

Liquid sorbents may be used with membrane contactors, such as scrubbers or strippers, that contact an air stream with or draw an air stream from the liquid sorbent across one or more hydrophobic porous membranes. Absorption of the contaminants by the liquid sorbent may be determined by a concentration of the contaminants in the corresponding air stream.

System 100 includes one or more contaminant sorption systems 104. Each contaminant sorption system 104 is configured to remove one or more contaminants from an air stream, such as a cabin air stream from cabin 102. Each contaminant sorption system 104 includes at least one scrubber 108 configured to absorb one or more contaminants from an air stream into the liquid sorbent.

System 100 also includes one or more contaminant desorption systems 106. Each contaminant desorption system 106 is configured to remove one or more contaminants from the liquid sorbent. Each contaminant desorption system 106 includes at least one stripper 110 configured to desorb one or more contaminants from the liquid sorbent into a contaminant air stream. The contaminant air stream may be further processed to separate, store, and/or transform the contaminants.

Contaminant removal system 100 may include a process control system that includes a controller 114 and one or more sensor sets (not shown). Controller 114 may include any of a wide range of devices, including control circuitry, processors (e.g., one or more microprocessors, one or more application specific integrated circuits (ASICs), one or more field programmable gate arrays (FPGAs), or the like), processing circuitry, one or more servers, one or more desktop computers, one or more notebook (i.e., laptop) computers, one or more cloud computing clusters, or the like.

Controller 114 may be configured to receive measurements from the one or more sensor sets and/or components of contaminant removal system 100 and/or send control signals to components of contaminant removal system 100. Controller 114 may be communicatively coupled to and configured to receive measurement signals from the one or more sensor sets, and other process control components (not shown) of contaminant removal system 100, such as: control valves for various streams; pumps; heaters; heat exchangers; compressors; and the like. The sensor sets may include instrumentation configured to detect any of a pressure, temperature, flow rate, and/or contaminant concentration (e.g., carbon dioxide concentration or water concentration) of a liquid or gas stream of contaminant removal system 100. Controller 114 may be configured to use the detected conditions to control operation of contaminant removal system 100 to function as described in the application.

Controller 114 is configured to control a concentration of one or more contaminants within the environment of cabin 102. For example, controller 114 may be configured to receive a concentration measurement for a contaminant, such as carbon dioxide, such as from a cabin air sensor set or a carbon dioxide concentration sensor in cabin 102. Controller 114 may be configured to determine whether the concentration measurement of the contaminant exceeds a concentration setpoint. For example, the concentration setpoint may be a target concentration of the contaminant for maintaining cabin 102 below a threshold contaminant concentration. Controller 114 may be configured to send, in response to the concentration measurement of the contaminant exceeding the concentration setpoint, a control signal to decrease a concentration of the contaminant in an air stream returned to cabin 102. For example, controller 114 may send a control signal to control a flow rate of the liquid sorbent mixture; a flow rate, humidity, and/or temperature of a sweep gas stream (not shown) into stripper 110; a temperature of the liquid sorbent mixture at scrubber 108 or stripper 110; a flow rate of the cabin air stream from cabin 102; or any other variable that may control a rate of removal of the contaminant from the cabin air stream from cabin 102.

System 100, which may include contaminant sorption system 104, contaminant desorption system 106, and/or processing equipment downstream of contaminant desorption system 106, may be relatively large. For example, carbon dioxide in an air stream may be absorbed, such as by using scrubber 108; desorbed, such as by using stripper 110; dehumidified, such as by using a compressor, a condenser, and a separator; and processed, such as by using a Sabatier reactor, a methane pyrolysis reactor, and an electrolysis system. Such a relatively large system may not be wholly contained in relatively small environments. As a result, air in portions of cabin 102 further away from contaminant sorption system 104 may not be treated to a same extent as air in portion of cabin 102 closer to contaminant sorption system 104. Air composition also may vary significantly throughout various cabins 102. As one example, air in some enclosed locations may not receive as good of circulation. As another example, contaminants may be produced from a particular source such as sleeping quarters while a crew member sleeping, that may be diluted into cabin air.

Rather than maintain system 100 as a physically proximate unit, components of system 100 related to contaminant absorption, including portions of contaminant sorption system 104 that interface with (e.g., circulate, filter, and/or absorb contaminants from) cabin air, may be physically separated from components of system 100 related to contaminant desorption, separation, storage, and/or transformation, including contaminant desorption system 106. Such physical separation of contaminant sorption system 104 and contaminant desorption system 106 may enable placement of contaminant sorption system 104 in a physical environment near to a source of the air stream and placement of contaminant desorption system 106 away from a source of the air stream. For example, components of contaminant sorption system 104 may be physically located near or within cabin 102. As a result, contaminant sorption system 104 may receive a cabin air stream without large amounts of ducting that may otherwise be necessary to transport cabin air from a particular portion of cabin 102. Further, such separation may enable contaminant sorption system 104 to more quickly and/or efficiently remove contaminants from cabin 102. For example, contaminant sorption system 104 may circulate larger amounts of air through cabin 102 to contaminant sorption system 104, may remove cabin air in areas with higher concentrations of contaminants prior to dilution, and/or may use less power to circulate large volumes of cabin air instead of smaller volumes of liquid sorbent.

Components of contaminant sorption system 104, such as components used to interface with an air stream from cabin 102 including scrubber 108, may be located in a local environment 101. Local environment 101 may include any environment that includes or is physically close to cabin 102. As one example, local environment 101 may be any environment closer to cabin 102 than remote environment 103. In other examples, local environment may be an environment of or surrounding (directly adjacent to) cabin 102. In the example of FIG. 1, cabin 102 and scrubber 108 are located in local environment 101. For example, scrubber 108 may be located in a room or volume, such as ducting, that is adjacent to cabin 102. In other examples, scrubber 108 may be located in cabin 102 or a structure fluidically coupled to cabin 102, such as a rack within cabin 102. In some examples in which system 100 includes more than one contaminant sorption system 104, at least one contaminant sorption system 104 may be located in local environment 101, while at least one contaminant sorption system 104 may be located in remote environment 103.

Components of contaminant desorption system 106, such as stripper 110, and optionally components of processing systems downstream of contaminant desorption system 106, such as a Sabatier system, may be located in one or more remote environments 103. Remote environment 103 may include any environment that does not include and is not physically close to cabin 102. For example, stripper 110 may be located in a room or volume that is not adjacent to cabin 102, such as a mechanical room. In some examples, remote environment 103 may be a central environment.

In addition to components related to absorption of contaminants, such as scrubber 108, each contaminant sorption system 104 includes a liquid sorbent circuit 112 configured to circulate the liquid sorbent between components of contaminant sorption system 104 located in local environment 101, such as scrubber 108, and components of contaminant desorption system 106 located in remote environment 103, such as stripper 110. Liquid sorbent circuit 112 may include equipment related to transporting the liquid sorbent between scrubber 108 and stripper 110 and conditioning the liquid sorbent for absorption of contaminants in scrubber 108. For example, components configured to heat or cool the liquid sorbent may be located in local environment 101, such that temperature-related losses may be reduced, while components related to pumping the liquid sorbent may be located in either or both local environment 101 and/or remote environment 103.

In system 100 of FIG. 1, contaminant sorption system 104 is illustrated as being fluidically coupled to contaminant desorption system 106, such that contaminant sorption system 104 may circulate liquid sorbent to and from contaminant desorption system 106 without reconfiguration other than component operation. However, in some examples, contaminant sorption system 104 may be configured to remove contaminants from cabin 102 and subsequently store the loaded liquid sorbent. For example, contaminant sorption system 104 may not be fluidically coupled to contaminant desorption system 106 during absorption of contaminants by contaminant sorption system 104. However, all or some components of contaminant sorption system 104, such as one or more liquid sorbent storage vessels, may be configured to removably couple to contaminant desorption system 106. The loaded liquid sorbent may be transported, such as in a liquid sorbent storage vessel, to contaminant desorption system 106, and contaminant desorption system 106 may remove the contaminants from the loaded liquid sorbent. For example, contaminant sorption system 104 may be a portable unit that includes components, such as scrubber 108 and liquid sorbent circuit 112, that are configured to circulate cabin air, absorb contaminants from cabin air, and store contaminants for further processing. In this way, environments that may only see period use or operation may be treated for contaminant removal without permanent installation of contaminant removal components.

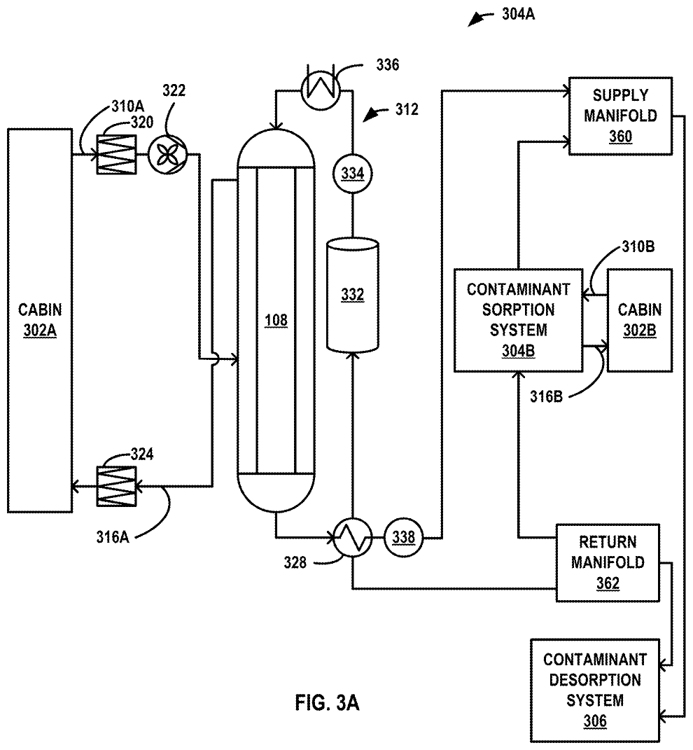

In addition to enabling placement of contaminant sorption system 104 into environments that may not be able to or efficiently contain an entirety of system 100, separating contaminant absorption functions from contaminant desorption functions may enable each contaminant sorption system 104 to more efficiently remove contaminants based on a particular composition of a respective air stream. FIG. 2 is a block diagram illustrating an example contaminant removal system 200 for absorbing contaminants using different contaminant sorption systems 204 and desorbing contaminants using a same contaminant desorption system 206. System 200 includes a first cabin 202A and a second cabin 202B (generically, “cabin 202”). Cabins 202 may be similar to cabin 102 in FIG. 1 described above.

System 200 includes two or more contaminant sorption systems 204A and 204B (individually, “contaminant sorption system 204”). In the example of FIG. 2, first contaminant sorption system 204A is configured to absorb contaminants in a cabin air stream from first cabin 202A, while second contaminant sorption system 204B is configured to absorb contaminants in a cabin air stream from second cabin 202B. Each contaminant sorption system 204 includes at least one scrubber 108 configured to absorb the one or more contaminants from an air stream from cabin 202 into a liquid sorbent. System 200 also includes a contaminant desorption system 206. Contaminant desorption system 206 includes at least one stripper 110 configured to desorb one or more contaminants from a liquid sorbent into a contaminant air stream. The contaminant air stream may be further processed to separate, store, and/or transform the contaminants. Each contaminant sorption system 204 includes a respective liquid sorbent circuit 212A and 212B (generically, “liquid sorbent circuit 212”) configured to circulate the liquid sorbent between scrubber 108 of the respective contaminant sorption system 204A or 204B and stripper 110 of contaminant desorption system 206.

Each cabin 202 may have an atmosphere having a different composition of contaminants. The composition of contaminants of each atmosphere may result from the contents of cabin 202, including a number, condition, and time of occupancy or operation of people or equipment in the respective cabin 202. For example, a cabin 202 that includes a higher number of personnel may have a higher concentration of carbon dioxide than a cabin that has a lower number of personnel. As a result, a cabin air streams received by a respective contaminant sorption system 204 may have a particular composition, different other cabin air streams. Additionally, a composition of the atmosphere of a cabin 202 may vary based on a time of day. For example, a cabin 202 that includes personnel exercising or performing a procedure may have a higher concentration of carbon dioxide during the procedure than before or after the procedure.

In some examples, contaminants in the air streams include one or more primary contaminants, such as carbon dioxide and water vapor, at various concentrations. A primary contaminant may include any contaminant derived from respiration or combustion, and/or that may have a concentration greater than about 1000 parts per million volume (ppmv) under stable operation. A concentration of the primary contaminants may depend on a volume and an occupancy of personnel and/or a presence and operating condition of machinery in cabins 202A and 202B. For example, a cabin having higher occupancy and/or lower volume may have a higher concentration of carbon dioxide and water vapor, while a cabin having a higher amount of machinery or greater operating conditions may have a higher concentration of combustion byproducts.

In some examples, contaminants in the air streams include one or more trace contaminants at various concentrations. A trace contaminant may include any contaminant that may have a concentration less than about 1000 ppmv under stable operation. Trace contaminants may be derived from a lubricant, a refrigerant, or a human occupant, and may include, but are not limited to, an alcohol, a hydrocarbon, a siloxane, an organosilicon compound, a ketone, a halocarbon, or ammonia. A composition of trace contaminants for each of the air streams may be different. For example, first cabin 202A may include primarily personnel, while second cabin 202B may include primarily machinery. As a result, first cabin 202A may have a relatively high concentration of trace contaminants derived from humans, while second cabin 202B may have a relatively high concentration of trace contaminants derived from machinery.

To accommodate a different composition within and/or between cabins 202A and 202B, each contaminant sorption system 204A and 204B may be configured to remove contaminants at a rate that maintains the composition of contaminants in the respective cabin 202 below a target threshold. As one example, first contaminant sorption system 204A may remove a particular set of contaminants at a particular rate due to a contaminant generation rate in first cabin 202A, while second contaminant sorption system 204B may remove a particular set of contaminants at a particular rate due to a particular contaminant generation rate in second cabin 202B, different from the rate of first contaminant sorption system 204A. As another example, first contaminant sorption system 204A may remove a particular set of contaminants at a particular rate due to a size of first cabin 202A, while second contaminant sorption system 204B may remove a similar set of contaminants at a different rate due to a different size of second cabin 202B. As another example, first contaminant sorption system 204A may remove different sets of contaminants at different rates at different times due to a variable contaminant generation rate in first cabin 202A, while second contaminant sorption system 204B may remove a particular set of contaminants at a steady rate due to a relatively stable contaminant generation rate in second cabin 202B. A contaminant removal rate of each contaminant sorption system 204 may be a function of component sizing and selection and/or component operation. By enabling different contaminant removal rates for different atmospheres, system 200 may more efficiently and/or effectively remove contaminants from environments.

Contaminant desorption system 206 may be configured to remove contaminants absorbed by both first contaminant sorption system 204A and second contaminant sorption system 204B. Desorption of contaminants from more than one contaminant sorption system 204 may enable contaminant desorption system 206 to have an overall smaller size and/or operate more efficiently than a separate contaminant desorption system 206 for a corresponding contaminant sorption system 204. For example, first cabin 202A may have a high concentration of contaminants at a particular period, while second cabin 202B may have a low concentration of contaminants during the particular period. Rather than size multiple contaminant desorption systems based on a maximum contaminant generate rate, contaminant desorption system 206 may be configured, such as through selection, sizing, and/or operation, for a contaminant removal rate for more than one atmosphere and up to an entire system, which may result in a capacity that is less than a cumulative capacity of discrete contaminant desorption systems.

While illustrated as including a single stripper 110, contaminant desorption system 206 may include multiple strippers in series or parallel. For example, contaminant desorption system 206 may include multiple strippers 110 arranged in parallel and configured to be selectively taken offline, such as for maintenance of a particular stripper 110 or to operate a particular number of strippers 110 to maintain a higher efficiency of contaminant desorption system 206 for a particular contaminant generate rate.

Contaminant removal system 200 may include a process control system that includes a controller 214 and one or more sensor sets (not shown), and may be similar to controller 114 of FIG. 1 unless otherwise stated. Controller 214 is configured to control a concentration of one or more contaminants within the environment of cabin 102. In some examples, controller 214 may be configured to operate contaminant sorption systems 204 differently. For example, due to a different composition of the atmosphere in cabins 202A and 202B, controller 214 may operate components of contaminant sorption systems 204A and 204B under different operating conditions to achieve different removal rates of contaminants.

Controller 214 may be configured to control a concentration of one or more contaminants within the atmosphere of each of first cabin 202A and second cabin 202B by controlling a rate of absorption of contaminants into the liquid sorbent in scrubber 108 of each contaminant sorption system 204. For example, controller 214 may be configured to receive concentration measurements for one or more contaminants, such as from a cabin air sensor set or a contaminant concentration sensor, for each of cabins 202A and 202B. Controller 214 may be configured to determine whether the concentration measurements of the contaminants exceed a concentration setpoint. Controller 214 may be configured to send, in response to the concentration measurement of the contaminant exceeding the concentration setpoint, a control signal to a corresponding contaminant sorption system 204 to decrease a concentration of the contaminant in an air stream returned to the respective cabin 202. For example, controller 214 may send a control signal to control a flow rate of the liquid sorbent mixture; a temperature of the liquid sorbent mixture at scrubber 108; a flow rate of the cabin air stream from cabin 202; or any other variable that may control a rate of removal of the contaminant from the cabin air stream from cabin 202.

In some examples, controller 214 may be configured to control a concentration of contaminants in the atmosphere according to requirements specific to the particular cabin 202. For example, a concentration of contaminants within a clean air stream for each cabin 202 may be maintained within a target range or below a target threshold. Depending on requirements for the particular cabin 202, the target range or target threshold may be different. Contaminant sorption systems 204A and 204B may be configured to generate clean air streams having particular compositions maintained within the respective target ranges or below the respective target thresholds. In this way, contaminant removal system 200 may be capable of more efficiently controlling different atmospheres having different requirements than a system that includes a single contaminant sorption system.

In some examples, controller 214 may be configured to control a concentration of one or more contaminants in each of cabin 202A and 202B by controlling a timing of absorption of contaminants into the liquid sorbent. For example, controller 214 may control first contaminant sorption system 204A to operate continuously, while controller 214 may control second contaminant sorption system 204B to operate periodically.

Controller 214 may be configured to control a concentration of one or more contaminants in the liquid sorbent by controlling a rate of desorption of contaminants from the liquid sorbent in stripper 110 of contaminant desorption system 206. For example, controller 214 may be configured to receive concentration measurements for one or more contaminants in the liquid sorbent, such as from a contaminant concentration sensor in stripper 110. Controller 214 may be configured to determine whether the concentration measurements of the contaminants exceed a concentration setpoint or are outside a concentration range. Controller 214 may be configured to send, in response to the concentration measurement of the contaminant exceeding the concentration setpoint or violating the concentration range, a control signal to contaminant desorption system 206 to decrease a concentration of the contaminant in the liquid sorbent. For example, controller 214 may send a control signal to control a flow rate of the liquid sorbent mixture; a flow rate, humidity, and/or temperature of a sweep gas stream into stripper 110; a temperature of the liquid sorbent mixture at stripper 110; or any other variable that may control a rate of removal of the contaminant from the liquid sorbent.

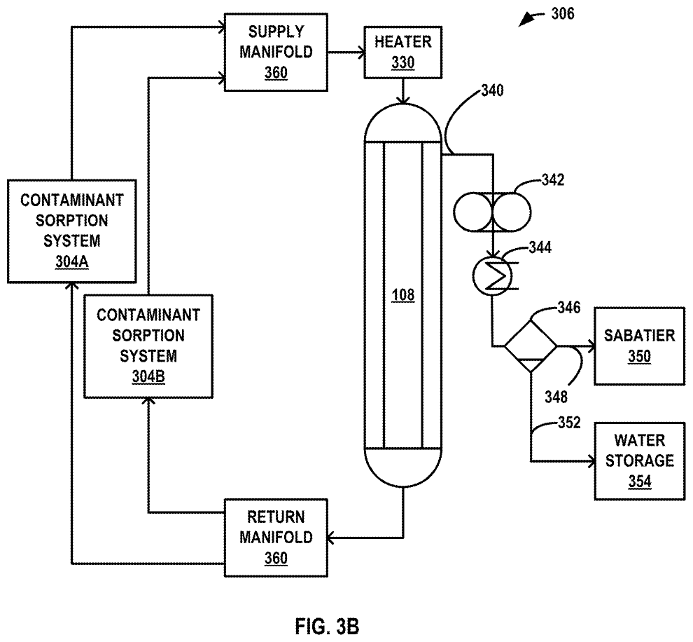

FIG. 3A is a schematic diagram illustrating two example contaminant sorption systems 304A and 304B of a contaminant removal system. For explanatory purposes, the example of FIG. 3A includes contaminant sorption system 304A illustrated and described in detail; however, unless noted otherwise, contaminant sorption system 304B may operate similar to contaminant sorption system 304A. Contaminant sorbent system 304A is configured to receive a cabin air stream 310A from cabin 302A, remove one or more contaminants from cabin air stream 310A, and discharge a clean air stream 316A back to cabin 302A. Contaminant sorbent system 304B is configured to receive a cabin air stream 310B from a cabin 302B, remove one or more contaminants from cabin air stream 310B, and discharge a clean air stream 316B back to cabin 302B.

The contaminant removal system may include a supply manifold 360 and a return manifold 362. Supply manifold 360 and return manifold 362 may be configured to consolidate two or more liquid sorbent circuits of contaminant sorbent systems 304 for discharge to a contaminant desorption system 306. Supply manifold 360 may be configured to receive a liquid sorbent from at least two contaminant sorption systems 304, such as contaminant sorption systems 304A and 304B, and discharge the liquid sorbent to contaminant desorption system 306. Return manifold 362 may be configured to receive the liquid sorbent from contaminant desorption system 400 and discharge the liquid sorbent to two or more contaminant sorption systems 304, such as contaminants sorption systems 304A and 304B. In this way, liquid sorbent may be consolidated prior to treatment of the liquid sorbent by contaminant desorption system 306.

Contaminant sorption system 304A includes a cabin air circuit (not labeled) configured to circulate cabin air between cabin 302A and scrubber 108. In the example of FIG. 3A, cabin air stream 310A includes a filter 320 configured to remove particulates from cabin air stream 310A prior to entry into scrubber 108 and a blower 322 configured to draw cabin air into scrubber 108, while clean air stream 316A includes a filter 324 configured to remove any leaked liquid sorbent and/or further filter clean air from clean air stream 316A prior to entry into cabin 302A. With respect to FIG. 1, components of contaminant sorption system 304A that interface with cabin air stream 310A and/or clean air stream 316A, such as filter 320, blower 322, scrubber 108, and filter 324, may be located in a local environment to cabin 302A.

Scrubber 108 is configured to absorb one or more contaminants from cabin air stream 310A into the liquid sorbent and discharge a clean air stream 316A to cabin 302A. Clean air stream 316A has a lower concentration of contaminants than cabin air stream 310A. For example, clean air stream 316A may have a concentration of carbon dioxide that is about 25% to about 99% less than a concentration of carbon dioxide in cabin air stream 310A.

Scrubbers 108 and/or strippers 110 described herein may include one or more membrane separators configured to flow air on a first side and flow liquid sorbent on a second, opposite side. For example, a membrane separator may include a plurality of parallel membrane contactors. In some examples, a membrane contactor may include a cylindrical module filled with parallel or woven hollow porous fibers forming a hydrophobic porous membrane. For example, dimensions of these hollow fibers could be less than about 3 mm, and the pore dimension could be less than about 2 microns. The high surface area of the hollow fiber membrane contactors enables a high mass transfer of contaminant gases, such as carbon dioxide and water, into the respective liquid sorbent using a relatively small system volume and weight. The material of the hollow fibers can be selected such that the liquid sorbent does not wet the pores, and the trans-membrane pressure is kept sufficiently low to prevent pore penetration. As a result, the membrane contactor may ensure that the liquid sorbent and gas stream do not need further separation, such that contaminant sorption systems 304 and/or contaminant desorption system 306 may act in a gravity-independent way without the use of moving parts. Fiber materials may include, but are not limited to, hydrophobic materials such as polypropylene, polyvinylidene fluoride, polysulfone, polyimide, polytetrafluoroethylene (PTFE), and the like. In some examples, a coating may be applied to reduce liquid flow through the pores. Coatings that may be used include, but are not limited to, PTFE, a crosslinked siloxane, perfluorinated polymers, functionalized nanoparticles, and the like to prevent liquid flow through the pores. While described in FIGS. 3A and 3B as flowing through a “tube” side, liquid sorbent flow can be either on the “tube” side or the “shell” side, while gas is flowed on the opposite side.

On a gas phase side, scrubber 108 is configured to receive cabin air from cabin air stream 310A that includes contaminants from cabin 302A. Scrubber 108 includes one or more separation membranes, each configured to flow (e.g., provide or direct flow of) cabin air from cabin air stream 310A on a gas phase side (e.g., a tube side) of the respective membrane and flow the liquid sorbent on a liquid phase side (e.g., a shell side) of the membrane. Contaminants may pass through the membrane due to a concentration gradient between the cabin air and the liquid sorbent and become absorbed by the liquid sorbent, while the liquid sorbent may not substantially flow through the membrane. As a result, clean air from clean air stream 316A discharged from scrubber 108 may have a lower concentration of contaminants than cabin air from cabin air stream 310A received by scrubber 108. Scrubber 108 is configured to discharge clean air stream 316A to cabin 302A.

On a liquid phase side, scrubber 108 is configured to receive unloaded liquid sorbent, such as from liquid sorbent storage 332. The unloaded liquid sorbent may flow through scrubber 108 and absorb carbon dioxide and other gaseous contaminants from cabin air through the membrane(s) of scrubber 108. As a result, the loaded liquid sorbent discharged from scrubber 108 may have a higher concentration of contaminants than the unloaded liquid sorbent received by scrubber 108. Scrubber 108 may discharge the loaded liquid sorbent containing the contaminants to contaminant desorption system 306.

Contaminant sorption system 304A includes liquid sorbent circuit 312 configured to circulate liquid sorbent between scrubber 108 and contaminant desorption system 306. For example, a pump 334 may pump unloaded liquid sorbent from stripper 110 into scrubber 108. Unloaded liquid sorbent may include unused liquid sorbent free of contaminants or regenerated liquid sorbent having a lower concentration of contaminants than the loaded liquid sorbent. In some examples, the unloaded liquid sorbent may be cooled by a heat exchanger 336 prior to entry into scrubber 108. In some examples, the loaded liquid sorbent may be preheated by a heat exchanger 328 and pumped by a liquid pump 338 prior to discharge to contaminant desorption system 306. A liquid sorbent storage 332 may store liquid sorbent, such as in a relatively cool state.

While liquid sorbent circuit 312 is illustrated as including components related to circulation and storage ionic liquid sorbent, such components may be located away from stripper 108 and other components that interface with cabin air stream 310A. For example, pumps 334 and 338, heat exchangers 328 and 336, and liquid sorbent storage 332 may be located away from scrubber 108, such as in remote environment 103 of FIG. 1 away from local environment 101. Such physical separation may enable a smaller size and weight of components of contaminant sorption system 300 located near cabin 302A. Alternatively, while described as being part of liquid sorbent circuit 312, components related to circulation, heating, cooling, and storage of the liquid sorbent may be located near to contaminant desorption system 306 or, in some examples, be part of contaminant desorption system 306. For example, contaminant desorption system 306 discussed below may include pumps 334 and 338, heat exchangers 328 and 336, and liquid sorbent storage 332.

In some examples, each contaminant sorption system 304 may be further configured to remove one or more trace contaminants other than water and carbon dioxide from cabin air stream 316. The one or more trace contaminants may absorb into the liquid sorbent and accumulate in the liquid sorbent until the liquid sorbent is replaced or regenerated at stripper 110. As will be described further below, the one or more trace contaminants may be desorbed by stripper 110 and discharged to a contaminant stream 340.

In some examples, contaminant sorption systems 304 may be configured to absorb contaminants from cabin air streams 316 having different compositions. For example, cabin 302A may be primarily configured for housing personnel, and may have an atmosphere that includes trace contaminants generated from humans. On the other hand, cabin 302B may be primarily configured for housing operating equipment, and may have an atmosphere that includes trace contaminants generated from machinery. As a result, cabin air stream 312A and 312B may have different concentrations of the trace contaminants.

To more efficiently or effectively absorb the different concentrations of the trace contaminants, contaminants sorption systems 304 may be configured specifically for a known or anticipated range of compositions of a corresponding cabin 302. Continuing with the above example, contaminant sorption system 304A may be configured to remove carbon dioxide, water vapor, methane, and other gases produced by humans at a particular generation rate to maintain concentrations of the contaminants below a particular threshold associated with safety or comfort.

To configure a particular contaminant sorption system 304, components of contaminant sorption system 304 may be selected and sized to efficiently absorb the contaminants over an anticipated range of compositions. For example, components of contaminant sorption system 304A, such as scrubber 108, pumps 334 and 338, liquid sorbent storage 332, and heat exchangers 328 and 336 may be sized to be capable of maintaining a particular removal rate of contaminants. In some examples, the components of contaminant sorption system 304A are sized according to a particular removal rate of a most limiting contaminant, such that each contaminant is maintained below a predetermined threshold. For example, while subject to change, a selection of trace contaminants and corresponding predetermined thresholds for a cabin of a spacecraft housing 4 personnel and 30,000 kg of equipment may be as shown in Table 1 below:

TABLE 1

| | Example | | |
|---|---|---|---|
| | Rate of | | |
| | Generation | Threshold | Threshold |
| Contaminant | (mg/day) | (mg/m³) | (ppmv) |
| Toluene | 62 | 0.46 | 0.12 |
| o-xylene | 110 | 0.46 | 0.12 |
| Furan | 1.3 | 0.07 | 0.02 |
| Dichloromethane | 66 | 0.10 | 0.03 |
| Acetone | 180 | 0.4 | 0.17 |
| Freon 218 | N/A | 99 | 13 |
| Carbon monoxide | 130 | 0.99 | 0.86 |
| Hydrogen | 170 | 3.0 | 36 |
| Methane | 1300 | 6.9 | 10 |
| Tremethylsilanol (TMSOH) | 5.1 | 1.4 | 0.15 |
| Hexamethylcyclotrisoloxane (D3 | 5.1 | 0.6 | 0.16 |
| siloxane) | | | |
| Ammonia | 210 | 1.1 | 1.5 |
| Methanol | 43 | 0.99 | 0.75 |
| Ethanol | 250 | 5.0 | 2.6 |
| n-butanol | 140 | 0.31 | 0.10 |
| Formaldehyde | 1.7 | 0.1 | 0.09 |
| Acetaldehyde | 5.7 | 0.45 | 0.25 |

In some examples, contaminant sorption system includes a membrane dehumidifier to capture humidity from cabin air 310A to increase humidity of clean air stream 316B. For example, the membrane dehumidifier may be positioned between cabin 302A and scrubber 108, such that cabin air received by scrubber 108 may include a lower humidity than cabin air received by contaminant sorption system 304A from cabin 302A. On one side, the membrane dehumidifier may be configured to receive cabin air stream 310A as a feed gas stream and discharge cabin air in a dehumidified air stream to scrubber 108 having a lower humidity. On an opposite side, the membrane dehumidifier may be configured to receive a dehumidified clean air stream from scrubber 108 and discharge clean air to clean air stream 316A having a higher humidity. By capturing humidity from cabin air prior to entry of cabin air from cabin air stream 310A into scrubber 108, a greater amount of humidity may be preserved. Removing water prior to going through scrubber 108 may also reduce an amount of water that is absorbed into the liquid sorbent and, correspondingly, reduce an amount of water that may be removed by stripper 110 through evaporative cooling. This water removal by the membrane dehumidifier may permit smaller sizing of scrubber 108 and/or stripper 110, and/or a smaller load on pumps 334 and 338 due to reduced volume, and/or may reduce an amount of power for heater 330 due to reduced evaporative cooling.

FIG. 3B is a schematic diagram illustrating an example contaminant desorption system 306 of a contaminant removal system. Contaminant desorption system 306 is configured to receive loaded liquid sorbent from one or more contaminant sorption systems 304 via supply manifold 360 and discharge unloaded liquid sorbent back to contaminant sorption system 304 via discharge manifold 362.

Stripper 110 is configured to desorb the carbon dioxide from the liquid sorbent into contaminant stream 340. On a liquid phase side, stripper 110 is configured to receive loaded liquid sorbent from contaminant sorption systems 304 and desorb contaminants from the loaded liquid sorbent. Stripper 110 includes one or more membranes, each configured to flow the loaded second liquid sorbent on one side (e.g., a shell side) of the membrane and contaminated air to contaminant stream 340 on an opposite side (e.g., a tube side) of the membrane. Contaminants may flow across fibers of the membrane due to a concentration gradient, while the liquid sorbent may not substantially flow across the fibers of the membrane. As a result, unloaded liquid sorbent discharged from stripper 110 may have a lower concentration of contaminants than the loaded liquid sorbent received by stripper 110. On a gas phase side, stripper 110 is configured to discharge the contaminants in contaminant stream 340. Contaminant stream 340 may be continuously removed from stripper 110 to assist migration of the contaminants from the loaded liquid sorbent into contaminant stream 340.

Contaminant desorption system 306 may include one or more heaters 330 upstream of stripper 108. Heaters 330 may be configured to heat the liquid sorbent prior to entry into stripper 108 to increase desorption of contaminants from the liquid sorbent.

In the example of FIG. 3B, a contaminant removal system may include one or more systems or components configured to further process contaminant stream 340. In some examples, the contaminant removal system include a Sabatier system 350 configured to generate hydrocarbons using carbon dioxide removed by contaminant desorption system 306. A Sabatier system 350 may require a water concentration of less than 2% to react hydrogen gas with carbon dioxide. However, in a life support application, a large amount of water may be present in cabin air stream 310A.

In some examples, a contaminant removal system includes a compressor 342, condenser 344, and water separator 346 configured to compress contaminant stream 340 and remove water from the compressed contaminant stream 340. For example, for carbon dioxide removed from contaminant desorption system 306 to be stored or recycled, compressor 342, condenser 344, and water separator 346 may compress contaminant stream 340 to a high pressure and remove nearly all water from contaminant stream 340.

Compressor 342 is configured to compress contaminant stream 340. A variety of compressors may be used for compressor 342 including, but not limited to, centrifugal compressors, positive displacement compressors, and the like. Condenser 344 may be configured to cool contaminant stream 340 and condense water from contaminant stream 340. For example, condenser 344 may be coupled to a refrigeration system or other cooling system that circulates a cooling medium to cool contaminant stream 340. A variety of condensers may be used for condenser 344 including, but not limited to, shell and tube heat exchangers, plate-fin, surface coolers, heat pipes, thermoelectric devices, cooling jackets, and the like. Water separator 346 may be configured to remove water from contaminant stream 340, discharge a dehumidified contaminant stream 348 to Sabatier system 350, and discharge water condensate stream 352 to water storage 354. A variety of water separators may be used for water separator 346 including, but not limited to, static phase separators, capillary phase separator, membrane phase separators, centrifugal/rotary separators, and the like.

With reference to both FIGS. 3A and 3B, a controller (not shown) may be communicatively coupled to and configured to receive measurement signals from one or more sensor sets, and other process control components (not shown) of contaminant sorption systems 304 and/or contaminant desorption system 306, such as: control valves for cabin air streams 310A and 310B, clean air streams 316A and 316B, contaminant stream 340, and inlets/outlets to heat exchangers 328 and 336, heater 330, liquid sorbent storage 332; pumps 334 and 338; blower 322, compressor 342 (e.g., pumping speed); and the like.

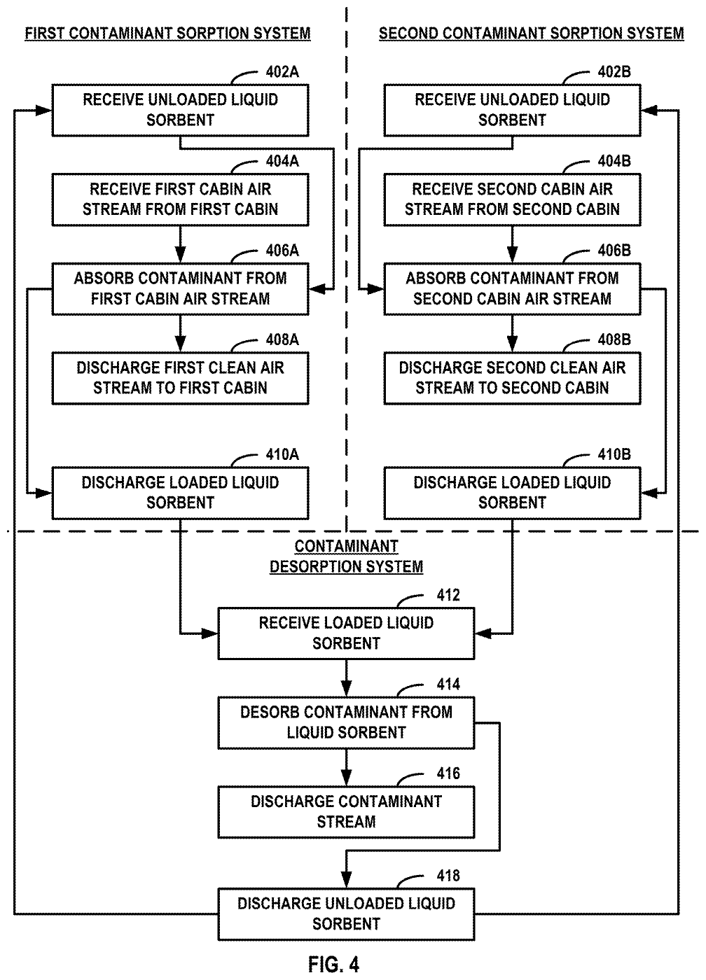

FIG. 4 is an example flowchart of a method for absorbing contaminants using different contaminant sorption systems and desorbing contaminants using a same contaminant desorption system. FIG. 4 will be described with respect to FIGS. 3A and 3B; however, other systems may be used to perform the method of FIG. 4.

The method of FIG. 4 includes removing contaminants from each of cabins 302A and 302B using a liquid sorbent. With regard to first contaminant sorption system 304A, the method includes receiving unloaded liquid sorbent from contaminant desorption system 306 (402A) and receiving a first cabin air stream 310A from first cabin 302A (404A). In some examples, the unloaded liquid sorbent may be received from contaminant desorption system 306 via discharge manifold 362.

The method further includes absorbing one or more contaminants from first cabin air stream 310A into the liquid sorbent (406A). For example, scrubber 108 of contaminant sorption system 304A may be maintained at particular conditions, such as temperature and flow rate of liquid sorbent, to facilitate transfer of the one or more contaminants into the liquid sorbent, such as by controlling pumps 334 and 338 to circulate the liquid sorbent between scrubber 108 and stripper 110 (of contaminant desorption system 306), controlling heat exchanger 336 to cool the liquid sorbent prior to entry into scrubber 108, and/or controlling heat exchanger 328 to recover a portion of heat from liquid sorbent discharge from stripper 110. These particular conditions may be based on a particular measured or anticipated composition of cabin air stream 310A.

The method further includes discharging first clean air stream 316A to first cabin 302A (408A) and discharging loaded liquid sorbent to contaminant desorption system 306 (410A). In some examples, the loaded liquid sorbent may be discharged to supply manifold 360 to be combined with other loaded liquid sorbent prior to desorption by stripper 110. Parameters of the loaded liquid sorbent, such as a concentration of contaminants in the loaded liquid sorbent or a temperature of the loaded liquid sorbent, may be particular to the composition of cabin air stream 310A. In some examples, a composition of cabin air stream 310A may be particular to cabin 302A. For example, a particular cabin may have different air quality requirements, such that a target threshold for clear air stream 316A may be different from other clean air streams.

Similarly, with regard to second contaminant sorption system 304A, the method includes receiving unloaded liquid sorbent from contaminant desorption system 306 (402B) and receiving a second cabin air stream 310B from second cabin 302B (404B). The method further includes absorbing one or more contaminants from second cabin air stream 310B into the liquid sorbent (406B). For example, scrubber 108 of contaminant sorption system 304B may be maintained at particular conditions to facilitate transfer of the one or more contaminants into the liquid sorbent. These particular conditions may be based on a particular measured or anticipated composition of cabin air stream 310B, which may be different from a composition of cabin air stream 310A. The method further includes discharging first clean air stream 316B to first cabin 302B (408B) and discharging loaded liquid sorbent to contaminant desorption system 306 (410B). Parameters of the loaded liquid sorbent may be particular to the composition of cabin air stream 310B, such that parameters of the loaded liquid sorbent from contaminant sorption system 304B may be different from parameters of the loaded liquid sorbent from contaminant sorption system 304A.

The method of FIG. 4 includes removing contaminants the liquid sorbent. With regard to contaminant desorption system 306, the method includes receiving loaded liquid sorbent from contaminant sorption systems 304A and 304B (412). The loaded liquid sorbent includes liquid sorbent from both contaminant sorption system 304A and 304B. In some examples, the loaded liquid sorbent may be received by supply manifold 360 and mixed.

The method includes desorbing the one or more contaminants from the liquid sorbent (414). For example, stripper 310 of contaminant desorption system 306 may be maintained at particular conditions, such as temperature and flow rate of liquid sorbent and vacuum from compressor 342, to facilitate transfer of the one or more contaminants from the liquid sorbent, such as by controlling compressor 342 to maintain a vacuum at stripper 110 or controlling heater 330 to heat the liquid sorbent prior to entry into stripper 110. These particular conditions may be based on a particular measured or anticipated composition of cabin air stream 310A.

While not shown in FIG. 4, the method may include further processing steps for contaminant stream 340. For example, in examples in which the contaminant includes carbon dioxide, the method may further include generating, by Sabatier system 350, hydrocarbons using the carbon dioxide. Prior to generating the hydrocarbons, contaminant stream 340 may be pressurized and purified by compressing contaminant stream 340 by controlling compressor 342, condensing water by controlling condenser 344, and separating water by controlling water separator 346.

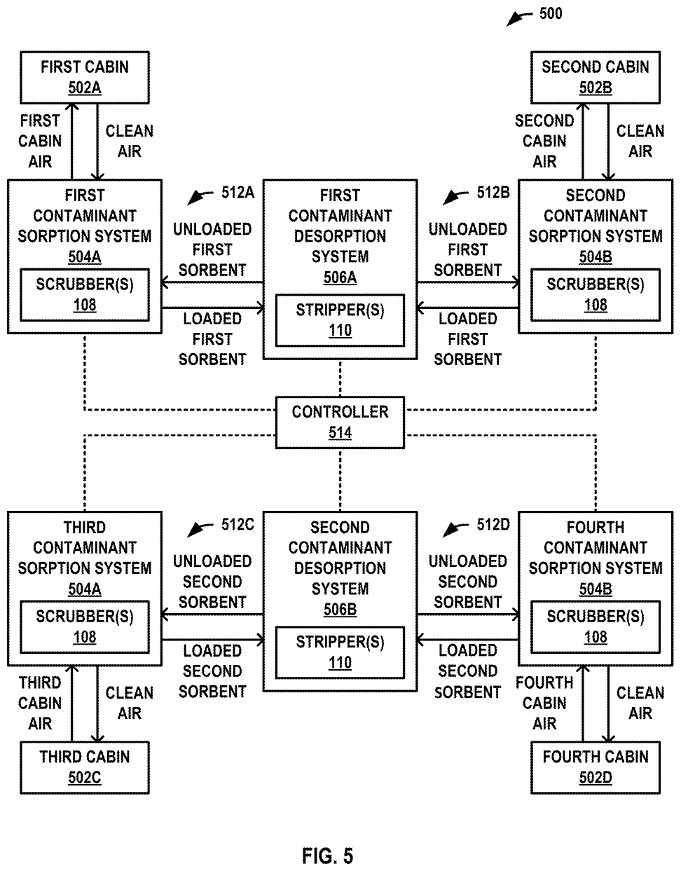

In some examples, contaminant removal systems may include more than one contaminant desorption system. Use of more than one contaminant desorption system may enable the use of different liquid sorbents that may be particularly suited to different contaminants, concentrations of contaminants, or generation rates of contaminants, and/or may enable a lower overall weight or volume of the contaminant removal system by locating contaminant desorption systems closer to corresponding contaminant sorption systems. FIG. 5 is a block diagram illustrating an example contaminant removal system for absorbing contaminants using different contaminant sorption systems and desorbing contaminants using different contaminant desorption systems.

System 500 includes a first contaminant sorption system 504A configured to absorb contaminants from a first cabin 502A into a first liquid sorbent, a second contaminant sorption system 504B configured to absorb contaminants from a second cabin 502B into the first liquid sorbent, and a first contaminant desorption system 506A configured to desorb contaminants from the first liquid sorbent. Similarly, system 500 includes a third contaminant sorption system 504C configured to absorb contaminants from a third cabin 502C into a second liquid sorbent, a fourth contaminant sorption system 504D configured to absorb contaminants from a fourth cabin 502D into the first liquid sorbent, and a second contaminant desorption system 506B configured to desorb contaminants from the second liquid sorbent. Each contaminant sorption system 504 includes at least one scrubber 108 and a respective liquid sorbent circuit 512A, 512B, 512C, 512D configured to circulate a first or second liquid sorbent between scrubber 108 and a stripper 110 of a respective contaminant desorption system 506.

Each of the first liquid sorbent and the second liquid sorbent may be selected to increase contaminant removal for particular contaminants or combinations of contaminants. Particular liquid sorbents may have a higher capacity or affinity for some contaminants than others. For example, an ionic liquid sorbent may have a higher affinity for contaminants having a higher polarity than a lower polarity. As a result, particular liquid sorbents may be better suited for removing contaminants from particular air streams having a composition of contaminants. An affinity or capacity of a liquid sorbent for a contaminant may be expressed by similarity in solubility parameters of a contaminant and a liquid sorbent. Contaminants whose solubility parameters are closer to a solubility parameter of the liquid sorbent may be transferred more effectively. Correspondingly, scrubber 108 and/or stripper 110 may more efficiently absorb or desorb a contaminant having a solubility parameter that is closer to a solubility parameter of the liquid sorbent.

While illustrated and described in the example of FIG. 5 as using two different liquid sorbents, in some examples, system 500 may be configured to use a same liquid sorbent. For example, system 500 may include two or more different contaminant desorption systems 506 that are located near the respective contaminant sorption system 504 to reduce an amount of infrastructure in liquid sorbent circuits for circulating liquid sorbent.

Example 1: A contaminant removal system includes a contaminant desorption system includes at least one scrubber located in a local environment of the cabin and configured to absorb the one or more contaminants from an air stream into the liquid sorbent; and a liquid sorbent circuit configured to circulate the liquid sorbent between the at least one scrubber and the at least one stripper of the contaminant desorption system.

Example 2: The contaminant removal system of example 1, wherein each liquid sorbent circuit comprises: a liquid pump configured to circulate the liquid sorbent; and a heat exchanger configured to cool the liquid sorbent prior to entry into the at least one scrubber.

Example 3: The contaminant removal system of any of examples 1 and 2, wherein the contaminant desorption system comprises one or more heaters upstream of the at least one stripper.

Example 4: The contaminant removal system of any of examples 1 through 3, wherein the one or more contaminants include carbon dioxide, and wherein the system further comprises a Sabatier system configured to generate hydrocarbons using the carbon dioxide.

Example 5: The contaminant removal system of any of examples 1 through 4, wherein at least one of the one or more contaminant sorption systems is configured to removably couple to the contaminant desorption system.

Example 6: A contaminant removal system includes one or more contaminant desorption systems, wherein each contaminant desorption system comprises at least one stripper configured to desorb one or more contaminants from a liquid sorbent, wherein the one or more contaminants comprise at least carbon dioxide; and two or more contaminant sorption systems, wherein each contaminant sorption system comprises: at least one scrubber configured to absorb the one or more contaminants from an air stream into the liquid sorbent; and a liquid sorbent circuit configured to circulate the liquid sorbent between the at least one scrubber and the at least one stripper of the contaminant desorption system.

Example 7: The contaminant removal system of any of examples 5 and 6, further includes a supply manifold configured to: receive the liquid sorbent from at least two of the two or more contaminant sorption systems; and discharge the liquid sorbent to at least one of the one or more contaminant desorption systems; and a return manifold configured to: receive the liquid sorbent from at least one of the one or more contaminant desorption systems; and discharge the liquid sorbent to at least two of the two or more contaminant sorption systems.

Example 8: The contaminant removal system of any of examples 6 and 7, wherein a composition of each of the air streams of the two or more contaminant sorption systems is different.

Example 9: The contaminant removal system of example 8, wherein the one or more contaminants of each of the air streams comprises at least one trace contaminant derived from a lubricant, a refrigerant, or a human occupant, and wherein a composition of the at least one trace contaminant for each of the air streams is different.

Example 10: The contaminant removal system of example 9, wherein the at least one trace contaminant comprises at least one of an alcohol, a hydrocarbon, a siloxane, an organosilicon compound, a ketone, a halocarbon, or ammonia.

Example 11: The contaminant removal system of any of examples 6 through 10, wherein each liquid sorbent circuit comprises: a liquid pump configured to circulate the liquid sorbent; and a heat exchanger configured to cool the liquid sorbent prior to entry into the at least one scrubber.

Example 12: The contaminant removal system of any of examples 6 through 11, wherein each contaminant desorption system comprises one or more heaters upstream of the at least one stripper.

Example 13: The contaminant removal system of any of examples 6 through 12, wherein the one or more contaminant desorption systems comprises: a first contaminant desorption system configured to desorb one or more contaminants from a first liquid sorbent; and a second contaminant desorption system configured to desorb one or more contaminants from a second liquid sorbent, different from the first liquid sorbent.

Example 14: The contaminant removal system of any of examples 6 through 13, further comprising a Sabatier system configured to generate hydrocarbons using the carbon dioxide.

Example 15: A method for removing contaminants from an environment includes absorbing, by a first contaminant sorption system, one or more contaminants from a first cabin air stream using a liquid sorbent; absorbing, by a second contaminant sorption system, one or more contaminants from a second cabin air stream using the liquid sorbent; and desorbing, by a contaminant desorption system, the one or more contaminants from the liquid sorbent.

Example 16: The method of example 15, wherein the contaminant desorption system comprises at least one stripper configured to desorb the one or more contaminants from the liquid sorbent, and wherein each of the first and second contaminant sorption systems comprises: at least one scrubber configured to absorb the one or more contaminants from the respective first or second air stream into the liquid sorbent; and a liquid sorbent circuit configured to circulate the liquid sorbent between the at least one scrubber of the respective first or second contaminant sorption systems and the at least one stripper of the contaminant desorption system.

Example 17: The method of example 16, further includes circulating, by a liquid pump, the liquid sorbent between the respective at least one scrubber and the at least one stripper of the contaminant desorption system; and cooling, by a heat exchanger, the liquid sorbent prior to entry into the at least one scrubber.

Example 18: The method of any of examples 15 through 17, wherein the one or more contaminants comprise at least carbon dioxide wherein a composition of the first cabin air stream and a composition of the second cabin air stream are different.

Example 19: The method of any of examples 15 through 18, wherein the one or more contaminants of each of the first and second cabin air streams comprises at least one trace contaminant derived from a lubricant, a refrigerant, or a human occupant, and wherein a composition of the at least one trace contaminant for each of the first and second cabin air streams is different.

Example 20: The method of any of examples 15 through 19, wherein the at least one trace contaminant comprises at least one of an alcohol, a hydrocarbon, a siloxane, an organosilicon compound, a ketone, a halocarbon, or ammonia.

Various examples have been described. These and other examples are within the scope of the following claims.

What is claimed is:

1. A contaminant removal system, comprising:
a contaminant desorption system comprising at least one stripper located in a remote environment from a cabin and configured to desorb one or more contaminants from a liquid sorbent, wherein the one or more contaminants comprise at least carbon dioxide; and
one or more contaminant sorption systems, wherein each contaminant sorption system comprises:
at least one scrubber located in a local environment of the cabin and configured to absorb the one or more contaminants from an air stream into the liquid sorbent; and
a liquid sorbent circuit configured to circulate the liquid sorbent between the at least one scrubber and the at least one stripper of the contaminant desorption system.

2. The contaminant removal system of claim 1, wherein each liquid sorbent circuit comprises:
a liquid pump configured to circulate the liquid sorbent; and
a heat exchanger configured to cool the liquid sorbent prior to entry into the at least one scrubber.

3. The contaminant removal system of claim 1, wherein the contaminant desorption system comprises one or more heaters upstream of the at least one stripper.

4. The contaminant removal system of claim 1,
wherein the one or more contaminants include carbon dioxide, and
wherein the system further comprises a Sabatier system configured to generate hydrocarbons using the carbon dioxide.

5. The contaminant removal system of claim 1, wherein at least one of the one or more contaminant sorption systems is configured to removably couple to the contaminant desorption system.

6. A contaminant removal system, comprising:
one or more contaminant desorption systems, wherein each contaminant desorption system comprises at least one stripper configured to desorb one or more contaminants from a liquid sorbent, wherein the one or more contaminants comprise at least carbon dioxide; and
two or more contaminant sorption systems, wherein each contaminant sorption system comprises:
at least one scrubber configured to absorb the one or more contaminants from an air stream into the liquid sorbent; and
a liquid sorbent circuit configured to circulate the liquid sorbent between the at least one scrubber and the at least one stripper of the contaminant desorption system.

7. The contaminant removal system of claim 5, further comprising:
a supply manifold configured to:
receive the liquid sorbent from at least two of the two or more contaminant sorption systems; and
discharge the liquid sorbent to at least one of the one or more contaminant desorption systems; and
a return manifold configured to:
receive the liquid sorbent from at least one of the one or more contaminant desorption systems; and
discharge the liquid sorbent to at least two of the two or more contaminant sorption systems.

8. The contaminant removal system of claim 6, wherein a composition of each of the air streams of the two or more contaminant sorption systems is different.

9. The contaminant removal system of claim 8,
wherein the one or more contaminants of each of the air streams comprises at least one trace contaminant derived from a lubricant, a refrigerant, or a human occupant, and
wherein a composition of the at least one trace contaminant for each of the air streams is different.

10. The contaminant removal system of claim 9, wherein the at least one trace contaminant comprises at least one of an alcohol, a hydrocarbon, a siloxane, an organosilicon compound, a ketone, a halocarbon, or ammonia.

11. The contaminant removal system of claim 6, wherein each liquid sorbent circuit comprises:
a liquid pump configured to circulate the liquid sorbent; and
a heat exchanger configured to cool the liquid sorbent prior to entry into the at least one scrubber.

12. The contaminant removal system of claim 6, wherein each contaminant desorption system comprises one or more heaters upstream of the at least one stripper.

13. The contaminant removal system of claim 6, wherein the one or more contaminant desorption systems comprises:
a first contaminant desorption system configured to desorb one or more contaminants from a first liquid sorbent; and
a second contaminant desorption system configured to desorb one or more contaminants from a second liquid sorbent, different from the first liquid sorbent.

14. The contaminant removal system of claim 6, further comprising a Sabatier system configured to generate hydrocarbons using the carbon dioxide.

15. A method for removing contaminants from an environment, comprising:
absorbing, by a first contaminant sorption system, one or more contaminants from a first cabin air stream using a liquid sorbent;
absorbing, by a second contaminant sorption system, one or more contaminants from a second cabin air stream using the liquid sorbent; and
desorbing, by a contaminant desorption system, the one or more contaminants from the liquid sorbent.

16. The method of claim 15,
wherein the contaminant desorption system comprises at least one stripper configured to desorb the one or more contaminants from the liquid sorbent, and
wherein each of the first and second contaminant sorption systems comprises:
at least one scrubber configured to absorb the one or more contaminants from the respective first or second air stream into the liquid sorbent; and
a liquid sorbent circuit configured to circulate the liquid sorbent between the at least one scrubber of the respective first or second contaminant sorption systems and the at least one stripper of the contaminant desorption system.

17. The method of claim 16, further comprising, by each of the first and second contaminant sorption systems:
circulating, by a liquid pump, the liquid sorbent between the respective at least one scrubber and the at least one stripper of the contaminant desorption system; and
cooling, by a heat exchanger, the liquid sorbent prior to entry into the at least one scrubber.

18. The method of claim 15, wherein the one or more contaminants comprise at least carbon dioxide wherein a composition of the first cabin air stream and a composition of the second cabin air stream are different.

19. The method of claim 15,
wherein the one or more contaminants of each of the first and second cabin air streams comprises at least one trace contaminant derived from a lubricant, a refrigerant, or a human occupant, and
wherein a composition of the at least one trace contaminant for each of the first and second cabin air streams is different.

20. The method of claim 15, wherein the at least one trace contaminant comprises at least one of an alcohol, a hydrocarbon, a siloxane, an organosilicon compound, a ketone, a halocarbon, or ammonia.
